(19) United States
(12) Patent Application Publication
(10) Pub. No.: US 2023/0162031 A1
(43) Pub. Date: May 25, 2023

(54) METHOD AND SYSTEM FOR TRAINING NEURAL NETWORK FOR GENERATING SEARCH STRING

(71) Applicant: Arctic Alliance Europe Oy, Turku (FI)

(72) Inventor: Petri Nyman, Nummela (FI)

(73) Assignee: Arctic Alliance Europe Oy, Turku (FI)

(21) Appl. No.: 17/988,900

(22) Filed: Nov. 17, 2022

(30) Foreign Application Priority Data
Nov. 19, 2021 (FI) 20216188

(51) Int. Cl. G06N 3/08

(52) U.S. Cl. CPC G06N 3/08

(57) ABSTRACT

Disclosed is a method (500) for training a neural network to find relevant references therefor. The method comprises obtaining (502), via a database arrangement (602), at least one document, selecting (504), via a data processing arrangement (604), an input from the obtained at least one document, obtaining (506), via the data processing arrangement (604), at least one search string corresponding to one of the selected input and the at least one document; characterized in that, generating (508), via the data processing arrangement (604), a training pair comprising the selected input and the corresponding obtained at least one search string and training, via the data processing arrangement (604), the neural network using the generated training pair to find the relevant references.

### TECHNICAL FIELD

The present disclosure relates generally to automated searching systems and more specifically, to a method for training a neural network to find relevant references.

### BACKGROUND

In recent times, the usage of search engines to look for information on the Internet has increased rapidly. Boolean based search strings formed by using proper keywords along with operators are widely used in search engines due to their generally accurate and repeatable results. However, generation of a proper set of key words and Boolean operators may require a specialist personnel and/or expert in the relevant field to efficiently and accurately use the search string to find the relevant references. Such a search technique may also take considerable amount of time if the search string used for the search is not accurate. Moreover, the set of key words used to form the search string may differ from one personnel to another such as, based on an experience, and hence, the obtained results of such a search may be different or inaccurate.

Conventionally, in order to solve the aforesaid problems, several techniques have been developed. Typically, artificial intelligence (AI) based systems have been developed to conduct searches based on a variety of inputs. For example, in case of patent searches, some neural networks may be trained with office action (prosecution history) data. In said systems, the office action data of patent applications is analyzed to identify documents as found by the examiners. The neural network is trained to associate the patent application with the identified X documents. However, search results are typically non-repeatable. That is, a search conducted at a first moment of time using a natural language phrase may provide a first result and if the same search is done later, results might be totally different due to continuous training. Thus, such process may be difficult to implement as the results change as function of time. Moreover, an interpretation of the natural language phrase given as the input by the user also changes as the neural network is trained, thus, makes the system to be less predictable.

Therefore, in light of the foregoing discussion, there exists a need to overcome the aforementioned drawbacks associated with techniques for generating the search string and provide an improved method and system for training a neural network to find relevant references.

### SUMMARY

An object of the present disclosure is to provide a method for training a neural network to find relevant references therefor. Another object of the present disclosure is to provide a system for training a neural network to find relevant references. Another object of the present disclosure is to provide a solution that overcomes at least partially the problems encountered in the prior art.

In an aspect, an embodiment of the present disclosure provides a method for training a neural network to find relevant references therefor, the method comprising:
obtaining, via a database arrangement, at least one document;
selecting, via a data processing arrangement, an input from the obtained at least one document;
obtaining, via the data processing arrangement, at least one search string corresponding to one of the selected input and the at least one document;
generating, via the data processing arrangement, a training pair comprising the selected input and the corresponding obtained at least one search string; and
training, via the data processing arrangement, the neural network using the generated training pair to find the relevant references.

In an embodiment, the present disclosure provides a method of generating at least one search string for an input query to find relevant references therefor, the method comprising:
inputting, via a data processing arrangement, the input query to the trained neural network according to any one of claims 1-9, characterized in that
   the neural network is trained, via the data processing arrangement, using a training pair, and the training pair, comprises an input from at least one document and a corresponding at least one another search string, is generated via the data processing arrangement; and
executing, via the data processing arrangement, the trained neural network to generate the one search string to find the relevant references.

In another aspect, an embodiment of the present disclosure provides a system for training a neural network to find relevant references therefor, the system comprising:
a database arrangement configured to store at least one document; and
a data processing arrangement, communicably coupled to the database arrangement, configured to:
   select an input from the at least one document;
   obtain at least one search string corresponding to one of the selected input and the at least one document; characterized in that-generate a training pair comprising the selected input and the corresponding obtained at least one search string; and
   train the neural network using the generated training pair.

In an embodiment, the present disclosure provides a system for generating a search string for an input query to find relevant references therefor, the system comprising:
a database arrangement configured to store the input query; and
a data processing arrangement, communicably coupled to the database arrangement, configured to:
   provide the input query to the trained neural network according to the system discussed in claims and present description; characterized in that
      the neural network is trained via a training pair comprising an input from the at least one document and a corresponding at least one another search string is generated;
   execute the trained neural network to generate the at least one search string to find the relevant references.

Embodiments of the present disclosure substantially eliminate or at least partially address the aforementioned problems in the prior art, and enable efficient generation of the search string for the input query and to find relevant references.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF DRAWINGS

Embodiments of the present disclosure will now be described, by way of example only, with reference to the following diagrams wherein:

FIG. 1 is a schematic illustration of a system for generating a search string for an input query to find relevant references, in accordance with an embodiment of the present disclosure;

FIG. 2 is a flowchart listing steps involved in a process for generating a training pair for training a neural network, in accordance with an embodiment of the present disclosure;

FIG. 3 is a flowchart listing steps involved in a process for training the neural network, in accordance with an embodiment of the present disclosure;

FIG. 4 is a flowchart listing steps involved in a process for finding the relevant references, in accordance with an embodiment of the present disclosure;

FIG. 5 is a flowchart illustrating steps of a method for training the neural network to find the relevant references, in accordance with an embodiment of the present disclosure; and

FIG. 6 is a block diagram of a system for training the neural network to the find relevant references, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In an aspect, an embodiment of the present disclosure provides a method for training a neural network to find relevant references therefor, the method comprising:
obtaining, via a database arrangement, at least one document;
selecting, via a data processing arrangement, an input from the obtained at least one document;
obtaining, via the data processing arrangement, at least one search string corresponding to one of the selected input and the at least one document;
generating, via the data processing arrangement, a training pair comprising the selected input and the corresponding obtained at least one search string; and
training, via the data processing arrangement, the neural network using the generated training pair to find the relevant references.

Typically, search strings may be generated manually by human intelligence and experience. However, the manual generation of search strings may require expert personnel for generating an accurate search string. Further, such process may be time-consuming and laborious and still be ineffective, as the generation of the search string may depend on the intelligence of the expert personnel. There have been several attempts to formulate solutions aimed at solving the aforementioned problems. However, such solutions when applied on millions of documents render the solutions ineffective in light of the computationally expensive requirements thereof. In light of a need to overcome such problems, the present disclosure provides an improved method for training a neural network to find relevant references therefor in an efficient manner. It may be appreciated that the neural network, also known as artificial neural network may be a network of artificial neurons that may imitate human brain. The neural networks are beneficial as, typically, one may use natural language as an input. Thus, the trained neural networks may be used by non-experts and are easy and fast to use. The neural network of the present disclosure may be implemented for generating search strings that will be operable to provide the relevant references upon execution. Herein, the search string may be a set of keywords separated by Boolean operators that may be used to find the relevant references. Herein, the relevant references may be patent applications and non-patentable literature such as, but not limited to, journals, research papers and articles. Notably, the neural network is trained for generating the search string using the present method.

The method comprises obtaining, via a database arrangement, at least one document. Herein, the at least one document comprises at least one of a patent application, a trademark application, a research paper, an article, a journal, a technical document and so forth, against which the neural network is trained. It will be appreciated that the neural network may require to be trained to find one or more relevant patent applications based on the at least one document (and information stored therein), wherein the at least one document may or may not be a patent application. For example, the at least one document may be a research paper or article instead of another similar patent application. The “database arrangement” refers to a structure and/or module that includes programmable and/or non-programmable components configured to store, process and/or share information and/or signals relating to the training of the neural network for finding the relevant references. The term “database” refers to an organized collection of structured information (or data) i.e., typically stored and accessed electronically. For example, the database arrangement may include relational databases, centralized database, distributed databases, etc. However, conventional databases are susceptible to security risks such as, but not limited to, compromise or unwanted access by a malicious actor, a crash or failure, unwanted alteration of data, accidental deletion of data, and the like. Thus, in light of the aforementioned risks, the database arrangement is selected based on the needs of the implementation to find the relevant references efficiently and securely.

The method comprises selecting, via a data processing arrangement, an input from the obtained at least one document. Generally, in order to train any neural network, an input is required to be provided. Herein, the selected input for training the neural network of the present disclosure may be obtained by extracting one or more text sections (or parts) from the obtained at least one document. The extraction of the one or more text sections comprises selecting at least one of: all of the one or more text sections, one of the at least one or more text sections, or at least one part of the one or more text sections. For example, the method may select a part of the at least one document, for example, a summary, a claim, an abstract portion, a technical paragraph i.e., a part of a larger document sufficient to indicate the context of the search operation or even a sub-part of the selected part, including relevant keywords or a few lines from the one or more text sections. Generally, the one or more text sections comprises of sentences that are 20 words long (approximately) in order to efficiently manage associated memory constraints and computational resources during training. In an example, the at least one document is a patent application, wherein a single claim may be extracted from the at least one document to be selected as the input. Notably, the selected claim may be any of the claims in the patent application and not necessarily claim one. In another example, the at least one document is a file wrapper (prosecution history) related to the patent application and may be used as the input. Beneficially, the method comprises selecting the most suitable input based on the obtained at least one document to provided results of higher accuracy while using minimal efforts.

Herein, the ‘processing arrangement’ (or the data processing arrangement) refers to a structure and/or module that includes programmable and/or non-programmable components configured to store, process and/or share information and/or signals relating to the training of the neural network for finding the relevant references. The data processing arrangement may be a controller having elements, such as a display, control buttons or joysticks, processors, memory and the like. Typically, the data processing arrangement is operable to perform one or more operations of the method for training the neural network to finding the relevant references. In the present examples, the data processing arrangement may include components such as memory, a processor, a network adapter and the like, to store, process and/or share information with other computing components, such as a user device, a remote server unit, a database arrangement.

Optionally, the data processing arrangement includes any arrangement of physical or virtual computational entities capable of enhancing information to perform various computational tasks. Further, it will be appreciated that the data processing arrangement may be implemented as a hardware server and/or plurality of hardware servers operating in a parallel or in a distributed architecture. Optionally, the data processing arrangement is supplemented with additional computation system, such as neural networks, and hierarchical clusters of pseudo-analog variable state machines implementing artificial intelligence algorithms.

Optionally, the data processing arrangement is implemented as a computer program that provides various services (such as database service) to other devices, modules or apparatus. Moreover, the data processing arrangement refers to a computational element that is operable to respond to and processes instructions to find the relevant references via the method. Optionally, the data processing arrangement includes, but is not limited to, an encoder, a transformer, a predictor, a microprocessor, a micro-controller, a complex instruction set computing (CISC) microprocessor, a reduced instruction set (RISC) microprocessor, a very long instruction word (VLIW) microprocessor, Field Programmable Gate Array (FPGA) or any other type of processing circuit, for example as aforementioned.

Optionally, selecting, via the data processing arrangement, the input from the obtained at least one document may involve parsing the at least one document such as, via a document parser, for analyzing the obtained at least one document and thereby extracting the relevant text therefrom. The parsing of the at least one document is based on pre-defined rules (or criterion), wherein the pre-defined rules involve selection of a preset matching data type (or text) from the at least one document, selection of a text from predefined or expected locations within the at least one document, and filtering the parsed at least one document to remove unwanted data fragments to reduce the amount of data to be required and thereby enabling faster parsing of the at least one document and hence improving the computational efficiency of the method. For example, based on the implementation, the method may be configured to parse the obtained at least one document for selection of a text, a number, a symbol, a table, or any other data representation form. Optionally, the selected input is a search query i.e., an unstructured query obtained directly from a user, which will be processed via the method to determine a more precise and structured search string (or query) to be ultimately executed to find the intended and/or relevant references via the method in an efficient manner in contrast to existing systems and methods.

In an embodiment, selecting the input, comprises extracting one or more text sections from the obtained at least one document based on at least one of a selectable user preference, a pseudo-random selection, and a completely random selection. As discussed, the input may be selected by extracting one or more text sections from the obtained at least one document. The input may be selected by extracting one or more text sections from the at least one document based on the selectable user preference. In another embodiment, the input may be selected by extracting one or more text sections from the at least one document based on the pseudo-random selection. It will be appreciated that the pseudo-random selection may be obtained by using computer inputs and/or algorithms that may not be completely random in nature. Herein, upon obtaining the at least one document as an input, the present method utilizes one or more machine learning algorithms to extract one or more text sections in either a partially or a completely random manner. The extracted one or more text sections may then be selected as the input. In yet another embodiment, the input may be selected by extracting one or more text sections from the at least one document may be based on the completely random selection. Notably, the completely random selection is in-deterministic and unpredictable in nature and enables provision of un-biased results. Herein, the one or more text sections may be extracted randomly and may be selected as the input. For example, the one or more text sections of a detailed description of embodiment part from a patent application may be randomly extracted and selected as the input.

In another embodiment, selecting the input, further comprises preprocessing the extracted text, via the data processing arrangement. The preprocessing of the extracted text may be done to generate a plurality of embeddings to be inserted into the database arrangement for enabling the method to train the neural network to generate the search string to find the relevant references. Beneficially, such a pre-processing step via the data processing arrangement enables the method to indexing the extracted text to understand the semantic context for further generating accurate search strings based on the semantic context. Herein, the preprocessing of the extracted text via the data processing arrangement may involve at least one of tokenization, truncation, concatenation, padding, stemming, lemmatization, classification, collection, re-arrangement and/or indexing, of the extracted text for enabling the neural network to be trained via the method to accurately find the relevant references therefor.

Moreover, optionally, for enabling the selected text to be further utilized, the method is configured to convert the extracted text, via the data processing arrangement (such as, an encoder), into a plurality of encoded embeddings. Herein, for generating the plurality of encoded embeddings, the data processing arrangement is configured to tokenize the extract keywords based on predefined parameters, wherein the predefined parameters involve at least one of frequency or occurrence of keywords, length of keyword, number of white spaces, context. The data processing arrangement may utilize at least one of whitespace tokenization (i.e., whitespaces in the extracted text), code tokenization (i.e., pre-defined codes or boundaries), sub-text tokenization, sub-tokenization, sentence tokenization, and BERT tokenization to tokenize the extracted text into multiple tokens which may further be grouped into one or more token groups of predefined sizes for enabling the method to perform parallel processing of the one or more token groups in a faster manner to efficient find the relevant references.

Optionally, the generation of the plurality of encoded embeddings may involve conversion of the plurality of tokens into vectors of real numbers based on feature learning techniques applied for natural language processing. The data processing arrangement may be configured to process the one or more token groups via at least one of an encoder, a transformer, or a predictor, for translating the plurality of tokens, in the one or more token groups, into the plurality of encoded embeddings. For example, the data processing arrangement is configured for mapping one or more of the plurality of tokens against a mapping database (for example, a vocabulary or dictionary database, an ontology database, etc.), wherein the encoded embeddings may be vectors of real numbers. Beneficially, such encoded embeddings may be utilized via the method for efficiently indexing the extracted keywords for quickly and accurately providing or finding the relevant references.

Optionally, the encoded embeddings are generated by implementing Sentence Bidirectional Encoder Representations from Transformers (SBERT). Conventionally, processing huge amounts of data would require huge amounts of computational power and time using conventional techniques, for example, searching for the most similar pair in a collection of 10,000 sentences requires approximately 50 million inference computations with existing techniques and thus, SBERT is utilized for generating semantically meaningful sentence embeddings to enable efficient and accurate finding of the relevant references via the method. Additionally, optionally, the generated plurality of encoded embeddings may be based on a predefined criterion, for example, using similarity or relevance scores. Herein, the method implements SBERT that utilizes a twin network capable of processing different sentences simultaneously and thereby improving the computational efficiency of the method.

The method further comprises obtaining, via the data processing arrangement, at least one search string corresponding to one of the selected input and the at least one document. The search string, also known as, search query may be obtained by extracting two or more keywords from the selected input that may be separated by operators such that when the search string is given as input to the database arrangement, the at least one document may be found. Typically, the method comprises training the neural network to utilize the extracted one or more text sections to obtain the at least one search string.

In an example, a training set comprising X1: ‘A system comprising a first wheel and a second wheel’, is provided; based on which the neural network is configured to generate the search string Y1: ‘bike AND wheel’. In another example, a training set X2: ‘A method for controlling temperature comprising steps of measuring a temperature, comparing the measured temperature with target and adjusting input power to electrical heater based on the comparison’, is provided; based on which the neural network generates the search string Y2: ‘heater AND temperature AND home automation’.

Optionally, obtaining the at least one search string, via the data processing arrangement, comprises generating the search string. Herein, generating the search string comprises extracting, via the data processing arrangement, two or more keywords from the input and adding at least one operator between each of two adjacent keywords of the two or more keywords. The keywords may give an idea of the content in the at least one document. The operators may include Boolean operators such as, AND, OR, NOT, numerical operators such ‘equal to’ having the symbol ‘=’, ‘greater than’ having the symbol ‘>’, ‘less than’ having the symbol ‘<’, ‘greater than or equal to’ having the symbol ‘>=’, ‘less than or equal to’ having the symbol ‘<=’ and ‘range’ having the symbol ‘:’. Other operators may be ‘parenthesis’ having the symbol ‘0’, ‘distance operators’ having the symbol ‘near’ or ‘nD’ (where, n may be any number) and so forth. Thus, between each of two adjacent keywords of the two or more keywords at least one operator may be added to form the search string. For example, if at least two keywords are bike and wheel, the search string may be ‘bike AND wheel’, for example. Herein, ‘AND’ operator is added between the at least two key words. It may be noted that that there may be two operators between two adjacent keywords, like * AND (*) wherein, * are keywords, and ‘AND’ ‘( )’ are operators.

Optionally, extracting the two or more keywords from the input comprises identifying, via the data processing arrangement, one or more words from the input based on at least one of word frequency, word collocations and co-occurrences. Typically, the method comprises utilization of linguistic information, morphological information, syntactic information, part of speech information, etc. to identify the one or more words or features from the selected input. The method may comprise utilizing existing techniques to identify the one or more words and/or features including, but not limited to, TF-IDF (short for term frequency-inverse document frequency), Bag of Words (BOW), Rapid Automatic Keyword Extraction (RAKE), TextRank model, Conditional Random Fields (CRF) and so forth. The term “word frequency” refers to the number of times the word occurs in the input. The term “word collocations” refer to two or more words placed in the vicinity of one another and the co-occurrences refers to words that occur together. In an embodiment, the two or more keywords from the input may be extracted based on word frequency. Herein, the word frequency of each word in the input may be derived, and the one or more words having higher word frequency may be identified and extracted as two or more keywords. For example, a first word having a highest word frequency and a second word having a second highest frequency may be identified and extracted as two keywords. In an embodiment, the two or more keywords from the input may be extracted based on word collocations. Herein, the one or more words that occur after some distance may be extracted as the two or more keywords. The keywords may be separated by the distance operator based on the word collocation to form the search string.

Optionally, the method further comprises sorting, via the data processing arrangement, the extracted keywords based on at least one of keyword frequency in the input and order of appearance of keyword in the input and arranging the keywords in the search string, as generated, based on the sorting. The keyword frequency may be the number of times the keyword appears in the input. In an embodiment, once, the keywords are extracted via the data processing arrangement, those may be sorted based on the keyword frequency in the selected input. For example, the keyword having a highest keyword frequency may be assigned as a first rank, the keyword having a second highest keyword frequency may be assigned as a second rank, and so on. Herein, sorting of the keywords, via the data processing arrangement, may be done by arranging keywords in the search string according to their rank. That is, the keyword having the first rank may be written first, the keyword having the second rank may be written second and so on in the search string. In another embodiment, the keywords may be sorted in order of appearance of keyword in the input. That is, herein, the keyword that appears first in the input may be assigned the first rank, the keyword that appear second in the input may be assigned the second rank and so on. The keywords may, then, be arranged based on the sorting. That is, the keyword that appears first in the input may written be first in the search string, the keyword that appears second in the input may be written second in the search string and so on.

Optionally, the method further comprises determining, via the data processing arrangement, one or more synonyms for at least one of the extracted two or more keywords and associating the determined one or more synonyms to the corresponding keyword using an ‘OR’ operator in the search string, as generated. It may be appreciated that the keywords may be represented by their synonyms in other relevant references. That is, it may not be necessary that each reference of the relevant reference uses the same keywords. Hence, for at least one of the extracted two or more keywords synonyms may be determined by using a synonym database. Notably, the method comprises utilizing linguistic information, morphological information, syntactic information, part of speech information and so forth to determine the synonyms for at least one of the two or more keywords. In an embodiment, synonyms of keywords may be determined for only those keywords that are higher up in the sorting such as, the keyword having first rank and the keyword having the second rank. The determined one or more synonyms may be associated to the keyword using the ‘OR’ operator in the search string. For example, the search string may be ‘(car OR automobile) AND wheel’. Herein, the synonym of ‘car’ is ‘automobile’, and the keyword ‘car’ is associated with the ‘automobile’ using the ‘OR’ operator.

In an embodiment, obtaining, via the data processing arrangement, the at least one search string comprises deriving a search string based on historical search records from a search database. The “search database” comprises both private and public searching databases, such as Boolean operator based search databases. It will be appreciated that different type of search databases may be used by the present method to derive the search strings such as, but not limited to, Google Patents, Espacenet (European Patent Office—worldwide patents), Patentscope databases, USPTO databases, World Intellectual Property Office (WIPO) databases (Patentscope), Indian Patent Advanced Search System (IPASS) databases or other proprietary search databases. Typically, the historical search records i.e., the previous records of the search strings used by a user(s), a system or method(s) are analyzed by the, via the data processing arrangement, neural network to derive and/or identify the search strings therefrom.

Optionally, obtaining, via the data processing arrangement, the at least one search string further comprises deriving the search string based on historical search results. Alternatively stated, the at least one search string is derived based on historical search results, wherein the neural network may be trained to utilize historical search results and corresponding outputs as a feedback mechanism to dynamically and continuously improve the method. Herein, the previous search results may be used directly by the present method and provided to the user. Optionally, the method comprises utilizing one or more machine learning algorithms to derive statistical inference using at least one of inductive learning, deductive inference and/or transductive learning to learn from the existing records (or existing results) and/or statistical search data to further generate the search results directly. Additionally, the search results may be further analyzed and compared to the at least one document to ensure a match i.e., provision of relevant results. Beneficially, such an implementation decreases the overall computation time of the search operation and increases the efficiency of the method.

The method further comprises generating, via the data processing arrangement, a training pair comprising the selected input and the corresponding obtained at least one search string; and training the neural network using the generated training pair. That is, upon obtaining the at least one search string corresponding to one of the selected input and the at least one document, the at least one search string is associated with the selected input, via the data processing arrangement, to generate the training pair. The training (i.e., the learning algorithm) of the neural network is achieved using the generated training pair. Generally, training of any neural network is done in either a supervised manner or in an unsupervised manner. Herein, since both the inputs and outputs are provided in the form of a training pair, the training of the neural network is done in a supervised manner (or supervised learning) to employ the generated training pair as the training data to learn therefrom. Notably, the training pair generated, via the data processing arrangement, are accurate and without errors or any bias due to the unbiased selection and processing of the input, via the data processing arrangement, for generating the at least one search string, for further provision of accurate or relevant results. Moreover, the supervised training of the neural network increases the accuracy and efficiency of the neural network to provide highly relevant results. However, it will be appreciated that the training of the neural network may be done using other types of training algorithms such as, but not limited to, unsupervised Learning, reinforcement learning, semi-supervised learning, self-supervised learning, multi-instance learning, without departing from the spirit and the scope of the present disclosure. In an example, the neural network is trained using stochastic gradient descent (SGD) technique using the generated training pair.

In an exemplary scenario, the training of the neural network is done using a given training set (X, Y), wherein ‘X’ is the selected input and ‘Y’ is the generated search strings. Some examples of the generated training pair include:

X1: A system comprising a first wheel and a second wheel; and Y1: bike AND wheel.

X2: A method for controlling temperature comprising steps of measuring a temperature, comparing the measured temperature with target and adjusting input power to electrical heater based on the comparison; and Y2: heater AND temperature AND home automation.

In an embodiment, the neural network may be trained using unsupervised learning to generate the training pair i.e., using only the selected input (X) for training and based on which, determine the corresponding at least one search string. For example, the selected input X: Apparatus for flying comprising a body, pair of wings and an engine attached to the body; is used by the neural network to determine the corresponding at least one search string and thereupon generate the training pair.

In an embodiment, the method further comprises executing, via the data processing arrangement, the derived search string in the said search database to identify one or more references as results thereof. Herein, the generated search string is used to perform a search using the search database to generate a plurality of results therefrom. Using the generated plurality of results, the method comprises identifying, via the data processing arrangement, the one or more references (which are relevant to the search) from the plurality of results. Further, the method comprises selecting, via the data processing arrangement, one reference from the one or more references based on a predefined criterion. The predefined-criterion refers to predefined rules dictating the selection, derivation, and/or identification of the search string, via the data processing arrangement, wherein the predefined criterion may allow a selectable user preference, a pseudo-random selection, and a completely random selection for un-biased and accurate results provision The selection of the one reference from the one or more reference may be done via a user (i.e., directly), the user preference, or automatically by the method. Upon selecting the one reference from the one or more references, via the data processing arrangement, the method further comprises selecting a reference input from the selected one reference and generating the training pair comprising the selected reference input and the corresponding derived search string.

In an embodiment, the at least one document is at least one patent document, and wherein the method comprises obtaining, via the data processing arrangement, a prosecution history of the at least one patent document. The “prosecution history” refers to the entire historical record of the examination of the patent document including the original patent application, examiner reports, amendments and responses from patent attorneys or agents, and any relevant notices and filing history. Upon obtaining the prosecution history, the method comprises selecting, via the data processing arrangement, an input from the prosecution history of the at least one patent document, wherein the input may be one or more text sections, a title, a summary, an abstract or any other relevant section of the prosecution history and/or the at least one patent document. The method further comprises extracting, via the data processing arrangement, a search string from the selected input of the at least one patent document and generating the training pair comprising the selected input from the at least one patent document and the extracted search string from the prosecution history of the at least one patent document.

According to aspects of the present disclosure, the present disclosure further provides a method for generating a search string for an input query to find relevant references therefor. Herein, the method comprises inputting, via a data processing arrangement, the input query to the trained neural network according to any one of the aforementioned embodiments of the method for training a neural network to find relevant references therefor. Further, characterized in that, the neural network is trained, via the data processing arrangement, using a training pair, wherein the training pair, comprises an input from at least one document and a corresponding at least one another search string, is generated via the data processing arrangement. The method further comprises executing, via the data processing arrangement, the trained neural network to generate the search string. Upon generating the search string, the method comprises using the generated search string as the input query to perform a final search on the search database to find the relevant results therefor to be provided to the user.

In another aspect, the present disclosure also provides a system for training a neural network to find relevant references therefor, the system comprising:
a database arrangement configured to store at least one document; and
a data processing arrangement communicably coupled to the database arrangement, wherein the data processing arrangement is configured to:
   select an input from the at least one document;
   obtain at least one search string corresponding to one of the selected input and the at least one document;
   generate a training pair comprising the selected input and the corresponding obtained at least one search string; and
   train the neural network using the generated training pair.

Additionally, the data processing arrangement is arranged in various architectures for responding to and processing the instructions for generating the search string and/or to find relevant results therefor via the method or system. Herein, the system elements may communicate with each other using a communication interface. The communication interface includes a medium (e.g., a communication channel) through which the system components communicate with each other. Examples of the communication interface include, but are not limited to, a communication channel in a computer cluster, a Local Area Communication channel (LAN), a cellular communication channel, a wireless sensor communication channel (WSN), a cloud communication channel, a Metropolitan Area Communication channel (MAN), and/or the Internet. Optionally, the communication interface comprises one or more of a wired connection, a wireless network, cellular networks such as 2G, 3G, 4G, 5G mobile networks, and a Zigbee connection.

Optionally, the system comprises one or more neural networks, including a first recurring neural network (RNN), a second RNN, a third RNN, a fourth RNN and a fifth RNN. The first recurring neural network (RNN), the second RNN and the third RNN form an encoder portion of the system and the fourth RNN and the fifth RNN form a decoder portion of the system. A first word, a second word, and a third word of a sentence of the input query is given as an input to the first recurring neural network (RNN), the second RNN and the third RNN respectively. The first word, the second word and the third word may be encoded in the form of an encoder vector and is fed as an input to the decoder portion of the system. The decoder portion of the system comprising the fourth RNN and the fifth RNN may decode the encoder vector to generate a first keyword and a second keyword of the search string.

In an example, language translation is done on a set of sentences from a first language (input) and a second language (output) and are provided as training data. Typically, the sentences used by the system are 3-20 words long to keep memory constrains and computational resources of the training reasonable. Further, the RNN networks face problems while dealing with larger sequential data sets and thus to improve the overall efficiency, the system may comprise Long-Short Term Memory (LSTM) type checks or gates to the RNN networks. After training, in the language translation example, a user can input a sentence in the first language. The first language words are considered and thereafter transformed to numbers by the encoder as inputs x1, x2, x3, . . . xN (wherein N is number of words in the input sentence) to the encoder part of the RNN network and the output vector is fed to decoder part of the RNN network and translation is provided as y1, y2, . . . yM (wherein M is number of words in the translated sentence). Notably, the number of words in the input sequence may be different the number of words in the output or translated sequence.

Optionally, for selecting the input, the data processing arrangement is configured to extract one or more text sections from the obtained at least one document based on one of: a selectable user preference, a pseudo-random selection, and a completely random selection.

In an embodiment, for generating the search string, the data processing arrangement is configured to extract two or more keywords from the input, sort the extracted keywords based on at least one of: keyword frequency in the input and order of appearance of keyword in the input, arrange the keywords in the search string, as generated, based on the sorting and add at least one operator between each of two adjacent keywords of the two or more keywords.

Optionally, the data processing arrangement is configured to determine one or more synonyms for at least one of the extracted two or more keywords and associate the determined one or more synonyms to the corresponding keyword using an ‘OR’ operator in the search string, as generated.

In an embodiment, for obtaining the at least one search string, the data processing arrangement is configured to derive a search string based on historical search records from a search database; execute the derived search string in the said search database to identify one or more references as results thereof; select one reference from the one or more references based on a predefined criterion; select a reference input from the selected one reference; and generate the training pair comprising the selected reference input and the corresponding derived search string.

In an embodiment, wherein the at least one document is at least one patent document, the data processing arrangement is configured to obtain a prosecution history of the at least one patent document; select an input from the prosecution history of the at least one patent document; extract a search string from the selected input of the at least one patent document; and generate the training pair comprising the selected input from the at least one patent document and the extracted search string from the prosecution history of the at least one patent document.

In an aspect, the present disclosure also provides a system for generating a search string for an input query to find relevant references therefor, the system comprising:
a database arrangement to store the input query; and
a data processing arrangement, communicably coupled to the database arrangement, configured to:
   provide the input query to the trained neural network according to the system for training the neural network to find relevant references therefor; characterized in that
      the neural network is trained via a training pair comprising an input from the at least one document and a corresponding at least one another search string is generated;
   execute the trained neural network to generate the at least one search string to find the relevant references.

That is, upon generating the search string, the system comprises using the search database (such as, a pure Boolean based search tool). Beneficially, the system generates the search string using the trained neural network that provides accurate results in an efficient manner.

In an exemplary scenario, we compare the present method and system for generating a search string for an input query to find relevant references therefor with existing pure Boolean based search tools and pure neural network based search tools to clearly illustrate the high efficiency and performance of the present method and system.

Generally, the setup and maintenance operation for pure Boolean based search tools require indexing of patent data from over millions of patent documents. Considering the indexing operation may be performed using 1 unit of (normalized) computing power, therefore the addition of additional patent documents to the database and consequent re-indexing of the database consumes 1*10⁻⁷ units of computing power (for a millions records, for example). Further, the implementation of the search operation i.e., searching the patent database using a search term requires 1*10⁻⁶ units of computing power, in such an example. More importantly, such pure Boolean based search tools would require human inputs for framing the search string which is time-consuming, inefficient, and laborious process.

In contrast to pure Boolean based search tools, the pure neural network based search tool are computationally expensive. For example, the pure neural network based search tools may utilize N-grams to perform natural language processing (NLP) related learning to find correlation between claims of patent and the text requires, for example, 100-1000 units of computing power. Further, addition of additional patent documents to the database and re-training the neural network consumes, for example, 0.1 to 10 units of computing power per addition and if a recursive method is used for retraining from time to time then, for example, 100 to 1000 units are consumed after adding an additional data set.

Notably, in contrast to the aforementioned pure Boolean based search tools and pure neural network based search tools, the present disclosure provides a system and a method that is computationally efficient, easier in operation, setup and maintenance. Typically, the system and method of the present disclosure comprises the computationally inexpensive setup and maintenance operation of the Boolean based search tools. The system and method comprising the neural network for generating the search string may require to generate approximately 10000 to 100000 learning pairs to be utilized to train the neural network. Thereupon, the trained neural network requires 0.1-10 units of computing power to perform the entire search operation. Further, the present system and/or method generate the search string using 1×10⁻⁶ units of computing power. Thus, by utilizing elements from the Boolean based search and generating the search string using the neural network, it is evident the disclosed method and system is computationally more efficient than the pure neural network based method as well as the Boolean based method, and further provide increasingly accurate results with further training and operation.

The present disclosure also provides a computer-readable storage medium comprising instructions which, when executed by a computer, cause the computer to carry out the steps of the method for ranking the items in the list in view of request. Examples of implementation of the non-transitory computer-readable storage medium include, but is not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

### DETAILED DESCRIPTION OF DRAWINGS

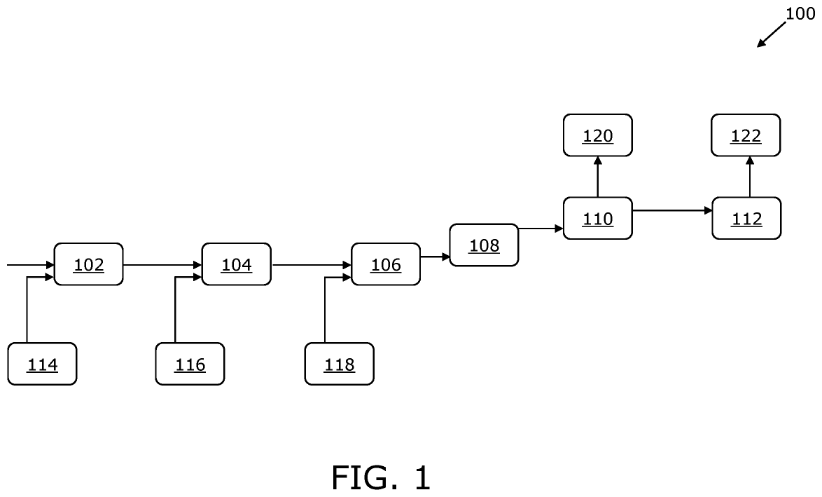

FIG. 1 is a schematic illustration of a system 100 for generating a search string for an input query to find relevant references, in accordance with an embodiment of the present disclosure. The system 100 comprises a first recurring neural network (RNN) 102, a second RNN 104, a third RNN 106, a fourth RNN 110 and a fifth RNN 112. The first recurring neural network (RNN) 102, the second RNN 104 and the third RNN 106 form an encoder portion of the system 100 and the fourth RNN 110 and the fifth RNN 112 a decoder portion of the system 100. A first word 114, a second word 116 and a third word 118 of a sentence of the input query is given as an input to the first recurring neural network (RNN) 102, the second RNN 104 and the third RNN 106, respectively. The first word 114, the second word 116 and the third word 118 may be encoded in the form of an encoder vector 108 and is fed as an input to the decoder portion of the system 110. The decoder portion of the system 110 comprising the fourth RNN 110 and the fifth RNN 112 may decode the encoder vector 108 to generate a first keyword 120 and a second keyword 122 of the search string.

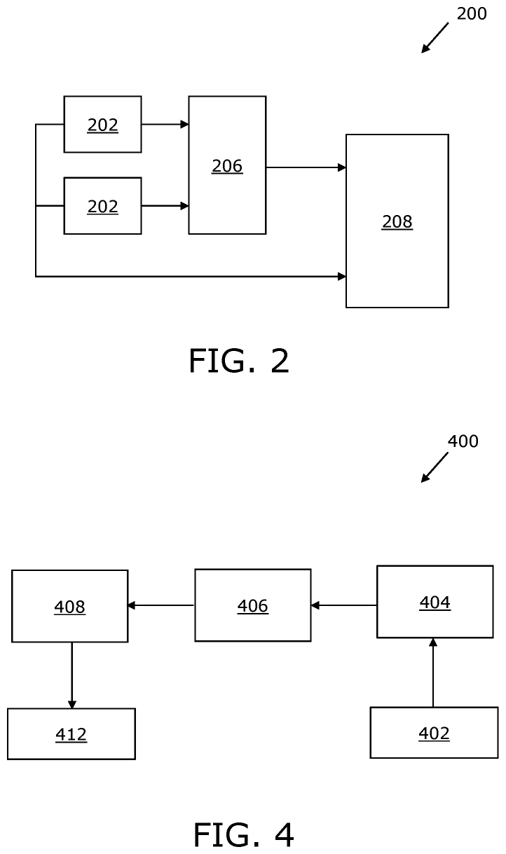

FIG. 2 is a flowchart listing steps involved in a process 200 for generating a training pair for training a neural network, in accordance with an embodiment of the present disclosure. The process 200 includes, at step 202, extracting a first text section which may be a claim of an at least one document. The process 200 includes, at step 204, extracting a second section, which may be text from a description of the at least one document, from the at least one document. Herein, the first text section and the second text section are selected as an input to the neural network. The process 200 includes, at step 206, receiving the extracted first text section and the second text section and implementing a search string generator to obtain at least one search string for the at least one document. The process 200 includes, at step 208, generating the training pair comprising the selected input and the corresponding obtained at least one search string.

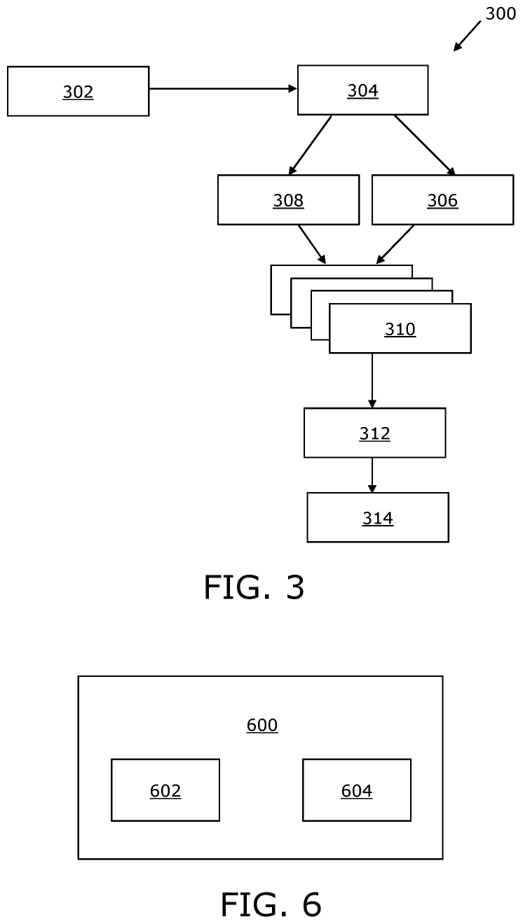

FIG. 3 is a flowchart listing steps involved in a process 300 for training the neural network, in accordance with an embodiment of the present disclosure. The process 300 includes, at step 302, receiving patent data. The process 300 includes, at step 304, obtaining ‘N’ number of documents from the patent data. The process 300 includes, at step 306, selecting the input from each document of the ‘N’ number of documents. Herein, one claim may be extracted from each document of the ‘N’ number of documents by employing a ‘claim extractor’ or the like. Thus, a total of ‘N’ number of claims may be extracted, one claim for each document of the ‘N’ number of documents. The process 300 includes, at step 308, obtaining at least one search string corresponding to each of the selected input of each document. Herein, a ‘search string generator’ or the like may be employed to generate the at least one search string for each document of the ‘N’ number of documents. A total of at least ‘N’ number of search strings may be generated, one search string for each document of the ‘N’ number of documents. The process 300 includes, at step 310, generating the training pairs comprising the selected input and the corresponding obtained at least one search string for each document of the ‘N’ number of documents. That is, the total of ‘N’ number of training pair may be generated. Each training pair may comprise one claim and the corresponding generated at least one search string for the corresponding document of the ‘N’ number of documents. The process 300 includes, at step 312, training the neural network. Herein, the neural network may be trained for each of the ‘N’ number of training pairs. The process 300 includes, at step 314, obtaining the trained neural network to be implemented for generating search strings for an input query to find relevant references therefor.

FIG. 4 is a flowchart listing steps involved in a process 400 for finding the relevant references, in accordance with an embodiment of the present disclosure. The process 400 includes, at step 402, obtaining the input query. The process 400 includes, at step 404, inputting the input query to the trained neural network. The process 400 includes, at step 406, executing the trained neural network to generate the search string. The process 400 includes, at step 408, inputting the generated search string in an indexed patent data base. The process 400 includes, at step 410, finding the relevant references.

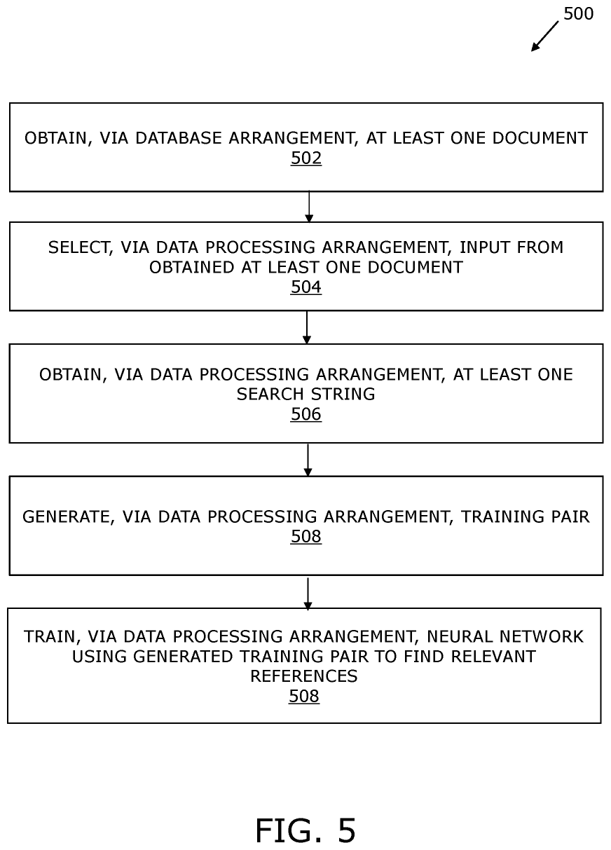

FIG. 5 is a flowchart illustrating steps of a method 500 of training the neural network to find the relevant references, in accordance with an embodiment of the present disclosure. The method 500 includes, at step 502, obtaining, via a database arrangement, the at least one document. The method 500 includes, at step 504, selecting, via the data processing arrangement, the input from the obtained at least one document. The method 500 includes, at step 506, obtaining, via the data processing arrangement, at least one search string. Herein, at least one search string corresponding to one of the selected input and the at least one document is obtained via the data processing arrangement. The method 500 includes, at step 508, generating, via the data processing arrangement, the training pair. Herein, the generated training pair comprises the selected input and the corresponding obtained at least one search string. The method 500 includes, at step 510, training, via the data processing arrangement, the neural network using the generated training pair.

FIG. 6 is a block diagram of a system 600 for training a neural network find relevant references therefor, in accordance with an embodiment of the present disclosure. The system 600 comprises a database arrangement 602 configured to store at least one document and a data processing arrangement 604 communicably coupled to the database arrangement 602, wherein the data processing arrangement 604 is configured to select an input from the at least one document, obtain at least one search string corresponding to one of the selected input and the at least one document, generate a training pair comprising the selected input and the corresponding obtained at least one search string and train the neural network using the generated training pair to find the relevant references.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

1. A method for training a neural network to find relevant references therefor, the method comprising:
obtaining, via a database arrangement, at least one document;
selecting, via a data processing arrangement, an input from the obtained at least one document;
obtaining, via the data processing arrangement, at least one search string corresponding to one of the selected input and the at least one document;
generating, via the data processing arrangement, a training pair comprising the selected input and the corresponding obtained at least one search string; and
training, via the data processing arrangement, the neural network using the generated training pair to find the relevant references.

2. The method according to claim 1, wherein obtaining the at least one search string comprises generating, via the data processing arrangement, the search string, and wherein generating the search string comprises:
extracting, via the data processing arrangement, two or more keywords from the selected input; and
adding, via the data processing arrangement, at least one operator between each of two adjacent keywords of the two or more keywords.

3. The method according to claim 2, wherein extracting the two or more keywords from the selected input comprises identifying, via the data processing arrangement, one or more words from the selected input based on at least one of: word frequency, word collocations and cooccurrences.

4. The method according to claim 2, further comprising:
sorting, via the data processing arrangement, the extracted keywords based on at least one of: keyword frequency in the selected input and order of appearance of keyword in the selected input; and
arranging, via the data processing arrangement, the keywords in the at least one search string, as generated, based on the sorting.

5. The method according to claim 2, further comprising:
determining, via the data processing arrangement, one or more synonyms for at least one of the extracted two or more keywords; and
associating, via the data processing arrangement, the determined one or more synonyms to the corresponding keyword using an ‘OR’ operator in the at least one search string, as generated.

6. The method according to claim 1, wherein obtaining the at least one search string comprises deriving, via the data processing arrangement, the at least one search string based on historical search records from a search database.

7. The method according to claim 6, further comprising:
executing, via the data processing arrangement, the derived at least one search string in the said search database to identify one or more references as results thereof;
selecting, via the data processing arrangement, one reference from the one or more references based on a predefined criterion;
selecting, via the data processing arrangement, a reference input from the selected one reference; and
generating, via the data processing arrangement, the training pair comprising the selected reference input and the corresponding derived at least one search string.

8. The method according to claim 1, wherein the at least one document is at least one patent document, and wherein the method further comprises:
obtaining, via the data processing arrangement, a prosecution history of the at least one patent document;
selecting, via the data processing arrangement, an input from the prosecution history of the at least one patent document;
extracting, via the data processing arrangement, a search string from the selected input of the at least one patent document; and
generating, via the data processing arrangement, the training pair comprising the selected input from the at least one patent document and the extracted at least one search string from the prosecution history of the at least one patent document.

9. The method according to claim 1, wherein selecting the input comprises extracting, via the data processing arrangement, one or more text sections from the obtained at least one document based on at least one of: a selectable user preference, a pseudo-random selection, and a completely random selection.

10. A method of generating at least one search string for an input query to find relevant references therefor, the method comprising:
inputting, via a data processing arrangement, the input query to the trained neural network according to claim 1, wherein
the neural network is trained, via the data processing arrangement, using a training pair, and the training pair, comprises an input from at least one document and a corresponding at least one another search string, is generated via the data processing arrangement; and
executing, via the data processing arrangement, the trained neural network to generate the one search string to find the relevant references.

11. A system for training a neural network to find relevant references therefor, the system comprising:
a database arrangement configured to store at least one document; and
a data processing arrangement communicably coupled to the data processing arrangement, wherein the data processing arrangement is configured to:
select an input from the at least one document;
obtain at least one search string corresponding to one of the selected input and the at least one document;
generate a training pair comprising the selected input and the corresponding obtained at least one search string; and
train the neural network using the generated training pair to find the relevant references.

12. The system according to claim 11, the data processing arrangement is configured to:
generate the at least one search string, wherein the obtained at least one search string comprises the generated at least one search string;
extract two or more keywords from the input;
sort the extracted keywords based on at least one of: keyword frequency in the input and order of appearance of keyword in the input;
arrange the keywords in the search string, as generated, based on the sorting; and
add at least one operator between each of two adjacent keywords of the two or more keywords.

13. The system according to claim 11, wherein for obtaining the at least one search string, the data processing arrangement is configured to:
derive a search string based on historical search records from a search database;
execute the derived search string in the said search database to identify one or more references as results thereof;
select one reference from the one or more references based on a predefined criterion;
select a reference input from the selected one reference; and
generate the training pair comprising the selected reference input and the corresponding derived search string.

14. The system according to claim 11, wherein the at least one document is at least one patent document, and wherein the data processing arrangement is configured to:
obtain a prosecution history of the at least one patent document;
select an input from the prosecution history of the at least one patent document;
extract a search string from the selected input of the at least one patent document; and
generate the training pair comprising the selected input from the at least one patent document and the extracted search string from the prosecution history of the at least one patent document.

15. A system for generating a search string for an input query to find relevant references therefor, the system comprising:
a database arrangement configured to store the input query; and
a data processing arrangement, communicably coupled to the database arrangement, configured to:
provide the input query to the trained neural network according to the system of claim 11; wherein the neural network is trained via a training pair comprising an input from the at least one document and a corresponding at least one another search string is generated;
execute the trained neural network to generate the at least one search string to find the relevant references.
